(19) United States
(12) Patent Application Publication
(10) Pub. No.: US 2024/0111972 A1
(43) Pub. Date: Apr. 4, 2024

(54) Device for locating stored objects via RFID detection

(71) Applicant: COMMISSARIAT A L’ENERGIE ATOMIQUE ET AUX ENERGIES ALTERNATIVES, Paris (FR)

(72) Inventors: Mélanie DESCHARLES, GRENOBLE (FR); Thierry THOMAS, GRENOBLE (FR); François FRASSATI, GRENOBLE (FR)

(21) Appl. No.: 18/375,467

(22) Filed: Sep. 30, 2023

(30) Foreign Application Priority Data
Oct. 4, 2022 (FR) 2210135

(51) Int. Cl. G06K 7/10; G01S 5/02; G06Q 10/087

(52) U.S. Cl. CPC G06K 7/10366; G01S 5/02; G06Q 10/087

(57) ABSTRACT

A device for locating objects stored in a storage unit includes a plurality of storage spaces, each object being equipped with an RFID tag, the object-locating device comprising: a plurality of inhibitor circuits each intended to be placed in an associated storage space and configured to prevent the RFID tag of the object from being read by an RFID reader, a control unit configured to control activation of the inhibitor circuits in a predetermined activation sequence; a locating unit configured to control the RFID reader, and to receive, in each step of the activation sequence, a list of identifiers of the objects stored in the storage unit, the list being supplied by the RFID reader, and configured to identify the storage space of each object based on the lists of identifiers and on the activation sequence.

### CROSS-REFERENCE TO RELATED APPLICATION

This application claims priority to foreign French patent application No. FR 2210135, filed on Oct. 4, 2022, the disclosure of which is incorporated by reference in its entirety.

### FIELD OF APPLICATION

The present invention relates to the field of locating objects tagged with RFID tags stored in a storage unit, via a sequence of activation/deactivation of detection of the RFID tags by a dedicated reader.

### BACKGROUND

The radio-frequency communication technique known as RFID is usable to detect the presence of physical objects in a general way. This technique is compatible with storage applications, logistics applications and applications involving presentation of objects.

Each stored object is equipped with an RFID tag in order to allow data to be retrieved remotely. The RFID tags of the stored objects contain an identifier of the object and potentially other useful information on the object, such as its nature, its trade name and its type.

Standards have been published concerning these devices, by way of which mention may be made, for example, of the standard ISO14443 for “contactless cards” and of the standard ISO18000-3 for “radio-tags” operating at the frequency of 13.56 MHz.

In these devices, a link is set up between the reader and one or more tags via a radio-frequency magnetic field. The coupling members are conductive circuits taking the form of loops, windings or coils that are referred to as “antenna circuits” or “antenna windings”.

Thus, the RFID tags of objects stored in the storage unit may be read by an RFID reader comprising an antenna allowing all the active “radio-tags” of the objects present to be read. The antenna is made up of conductive windings forming an inductive circuit. Read out is achieved through magnetic coupling between the antenna and the RFID tags at a predetermined resonant frequency, allowing information to be exchanged. Thus, it is possible to obtain a list of the objects present in the storage unit. This is particularly useful, by way of example, when inventorying stored objects.

The storage unit comprises a plurality of storage spaces that are delineated physically (partitions, walls) or virtually (by markings). The drawback of known solutions for this type of device for storing objects is that exploration through RFID communication is limited to detecting and inventorying the objects present, and does not allow the location of each object in the storage unit to be determined.

There is therefore a need to develop a solution allowing objects stored in a storage unit comprising a plurality of storage spaces to be located.

Patent application WO200845075 describes a gaming table provided with an array of antennas forming a plurality of read-out channels for an RFID radio-frequency link. Objects equipped with an RFID tag are placed on this table. This solution is applicable only at high frequencies—it requires the dimensions of the antenna not be too small with respect to the resonant wavelength. In addition, this solution is incompatible with an inductive RFID radio-frequency link. The major drawback is the need to use a plurality of read-out antennas to locate the objects. This approach results in complexity in the structure of the antenna of the reader, which takes the form of a switched antenna array. This leads to complexity in the hardware required to implement it and to a high power consumption.

### SUMMARY OF THE INVENTION

The subject of the invention is a device for locating objects stored in a storage unit comprising a plurality of storage spaces, each object being equipped with an RFID tag, said object-locating device comprising:
a plurality of inhibitor circuits each intended to be placed in an associated storage space and configured, when one of said objects is stored in the associated storage space and when said inhibitor circuit is activated, to prevent the RFID tag of said object from being read by an RFID reader,
a control unit configured to control activation of the inhibitor circuits in a predetermined activation sequence;
a locating unit configured to control the RFID reader, and to receive, in each step of the activation sequence, a list of identifiers of the objects stored in the storage unit, said list being supplied by the RFID reader, and configured to identify the storage space of each object based on the lists of identifiers and on the activation sequence.

According to one particular aspect of the invention, the inhibitor circuit is able to transpose the resonant frequency of the RFID tag to a second resonant frequency through magnetic coupling when it is activated.

According to one particular aspect of the invention, the activation sequence comprises:
an initializing step in which all the inhibitors are deactivated so as to list all the objects stored in the storage unit;
a succession of steps in which only some of the inhibitors are activated in the activation sequence.

According to one particular aspect of the invention, the locating device according to the invention further comprises said storage unit such that the storage spaces are dimensioned so that the magnetic-coupling coefficient between, on the one hand, an inhibitor circuit and, on the other hand, the RFID tag of the object placed in the storage space associated with said inhibitor circuit, is comprised between 0.5 and 1.

According to one particular aspect of the invention, the second resonant frequency is comprised between 5 MHz and 10 MHz.

According to one particular aspect of the invention, each inhibitor comprises:
an LC circuit comprising at least one inductive element connected in series with at least one capacitive element; and
a voltage-controlled switch for controlling said LC circuit closed.

According to one particular aspect of the invention, the voltage-controlled switch comprises a PIN diode having a first electrode connected to a first control voltage and a second electrode, the conductivity state of the PIN diode being controlled by a biasing circuit.

According to one particular aspect of the invention, the biasing circuit comprises a tank circuit connected between the first electrode of the diode and the first control voltage, the tank circuit having a high impedance at the resonant frequency of the RFID tag corresponding to the configuration of a deactivated inhibitor circuit.

According to one particular aspect of the invention, the voltage-controlled switch is a CMOS transistor.

According to one particular aspect of the invention, the inhibitors are produced on a substrate, and, in each inhibitor circuit, the inductive element is formed by at least a first planar coil comprising a plurality of spiraling metal tracks placed on at least one side of said printed circuit board.

According to one particular aspect of the invention, the inductive element further comprises a circular second planar coil and the first coil is circular in shape and has a diameter equal to that of the second planar coil.

### BRIEF DESCRIPTION OF THE DRAWINGS

Other features and advantages of the present invention will become more clearly apparent on reading the following description with reference to the following appended drawings:

FIG. 1a illustrates a top view of a schematic of the locating device according to the invention.

FIG. 1b illustrates a front view of one portion of the locating device according to the invention.

FIG. 2 illustrates a flowchart of the steps of the sequence for controlling the operation of the locating device according to the invention.

FIG. 3 illustrates an inhibitor circuit according to a first embodiment of the invention.

FIG. 4a illustrates one example of the gain curve of the magnetic-field response of the assembly formed by the RFID tag of an object and the inhibitor circuit when the associated inhibitor circuit is activated and the gain curve of the RFID tag of an object when the associated inhibitor circuit is deactivated.

FIG. 4b illustrates one example of the gain curve of the voltage across the terminals of the antenna circuit of the RFID tag of an object when the associated inhibitor circuit is activated and the gain curve of the RFID tag of an object when the associated inhibitor circuit is deactivated.

FIG. 5a illustrates the inhibitor circuit according to a second embodiment of the invention.

FIG. 5b illustrates the inhibitor circuit according to a third embodiment of the invention.

FIG. 6a illustrates a top view of one example of implementation of the inhibitor circuit according to the invention.

FIG. 6b illustrates a cross-sectional view of one example of implementation of the inhibitor circuit according to the invention.

### DETAILED DESCRIPTION

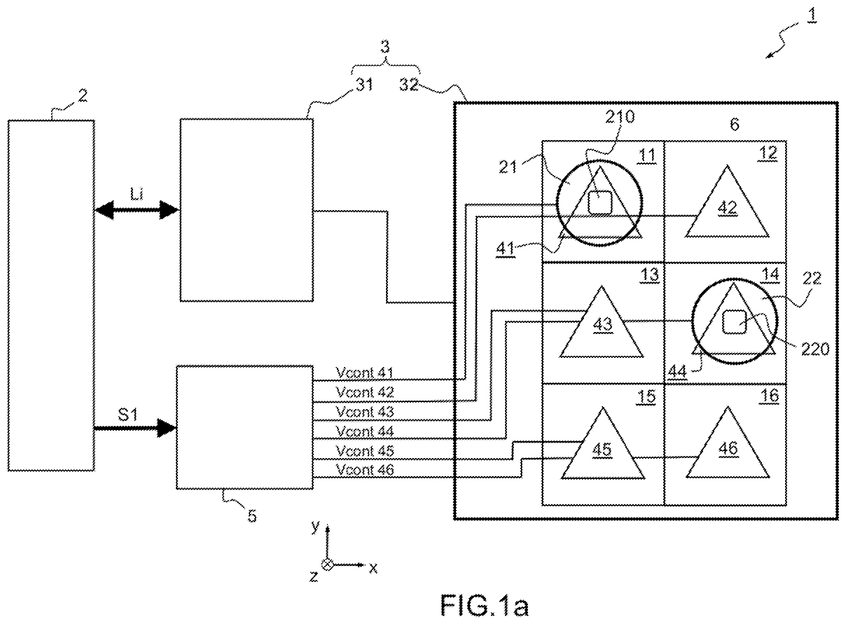

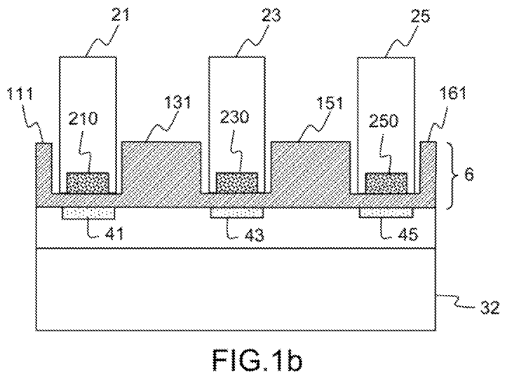

FIG. 1A illustrates a top view of a schematic of the locating device 1 according to the invention. The device 1 for locating objects comprises a storage unit 6 comprising a plurality of storage spaces for receiving stored objects; an RFID reader 3; a plurality of inhibitor circuits 41, 42, 43, 44 each intended to be placed in one associated storage space; a control unit 5; and a locating unit 2.

In order to illustrate the invention, by way of indication and non-limitingly, a storage unit 6 will be described that comprises six storage spaces 11 to 16 in which two objects are stored: the object 21 stored in storage space 11 and the object 22 stored in storage space 14. The storage spaces are delineated by physical obstacles (walls or partitions) or by markings delineating the storage spaces. The object 21 is equipped with an RFID tag 210. The RFID tag 210 stores information allowing the object 41 to be identified, such as an identifier denoted A. The object 22 is equipped with an RFID tag 220. The RFID tag 220 stores information allowing the object 22 to be identified, such as an identifier denoted B.

The RFID reader 3 comprises an antenna 32 covering the entire area occupied by the storage unit 6, in combination with a processing circuit 31. The antenna is able to detect objects present in the storage unit through magnetic coupling with the associated RFID tags. The processing unit 31 is configured to generate a list Lᵢ of the identifiers associated with the objects detected by the antenna 32.

An inhibitor circuit 41 to 46 is placed at the bottom of each storage space 11 to 16 of the storage unit 6. Each inhibitor circuit is configured to prevent the RFID tag of the object stored in the storage space associated therewith from being read by the RFID reader 3. When the inhibitor circuit is deactivated, the object stored in the storage space associated with said inhibitor circuit may be detected via the RFID reader through magnetic coupling at a first resonant frequency called the “working frequency”. Generally, the working frequency is predetermined by the construction of the RFID system and RFID reader 3 associated with the RFID tags (210 and 220). The RFID antenna 32 is connected to the processing unit 31, which generates the HF signal applied to the antenna 32 and determines the working frequency. In the case illustrated, when the inhibitor circuit 41 is activated, detection of the object 21 by the RFID antenna 32 is inhibited. When the inhibitor circuit 41 is deactivated, the object 21 is detectable by the RFID antenna 32 at the predetermined working frequency. Likewise, when the inhibitor circuit 44 is activated, detection of the object 22 by the reader 3 via its RFID antenna 32 is inhibited. When the inhibitor circuit 44 is deactivated, the object 22 is detectable by the reader 3 via its RFID antenna 32 at the predetermined working frequency.

In order to obtain the effect of inhibiting the RFID read out, each inhibitor circuit must be placed in the storage space so as to be in proximity to the RFID tag of the object when the latter is stored in said storage space. The expression “in proximity to” is understood to mean a position in a sphere of radius smaller than 10 mm from the inhibitor. The proximity between the inhibitor circuit and the tag of the stored object allows the magnetic coupling between these two components to be maximized. The action of the inhibitor circuit effects read out of a tag when the magnetic-coupling coefficient between the two antenna circuits, that of the inhibitor and that of the RFID tag, is located between 0.5 and 1. Advantageously, the stored object is placed so as to align its RFID tag with the associated inhibitor, and so as to minimize the distance separating them, in order to maximize the magnetic-coupling coefficient. FIG. 1b illustrates one example with optimization of the magnetic-coupling coefficient between each RFID tag and the associated inhibitor circuit. Specifically, the storage spaces 11, 13 and 15 of the storage unit 6 are delineated by physical walls 111, 131, 151 and 161. The delineation by the physical walls ensures alignment between the RFID tag of each placed object and the inhibitor circuit housed at the bottom of the storage space dedicated to said object. The distance separating an inhibitor circuit from tag of the stored object varies between 0.5 mm and 5 mm along the vertical axis (y). This allows the magnetic-coupling coefficient between the inhibitor circuit and the RFID tag of a stored object to be maximized and therefore the inhibition performance of each inhibitor circuit to be improved.

The control unit 5 is configured to control activation of the inhibitor circuits 41, 42, 43 and 44 in a predetermined activation sequence. One example of a possible activation sequence will be detailed in a subsequent section. Each inhibitor circuit is controlled by a control signal specific thereto. This allows multiple combinations of inhibition configurations to be achieved by activating at least some of the inhibitor circuits during each step of the activation sequence. By way of example, the inhibitor circuit 41 associated with the storage space 11 is controlled by the control signal Vcont41 delivered by the control unit 5. By way of example, it is possible for the control unit 5 to be a programmable microcontroller. The control signals are propagated via wired electrical connections.

The locating unit 2 is configured to receive, in each step of the activation sequence, a list of identifiers of the objects stored in the storage unit, said list being supplied by the RFID reader 3. In addition, the locating unit is configured to identify the storage space of each object based on the lists of identifiers and on the activation sequence. It is a question of data processing that may be performed by a computational algorithm implemented in a calculator or computer. The locating unit 2 further controls the control unit 5 depending on the read-out results supplied by the processing circuit 31. Specifically, the locating unit 2 sends read-out orders to the processing unit 31 and collects read-out results (for example, the list of identifiers of the RFID tags read).

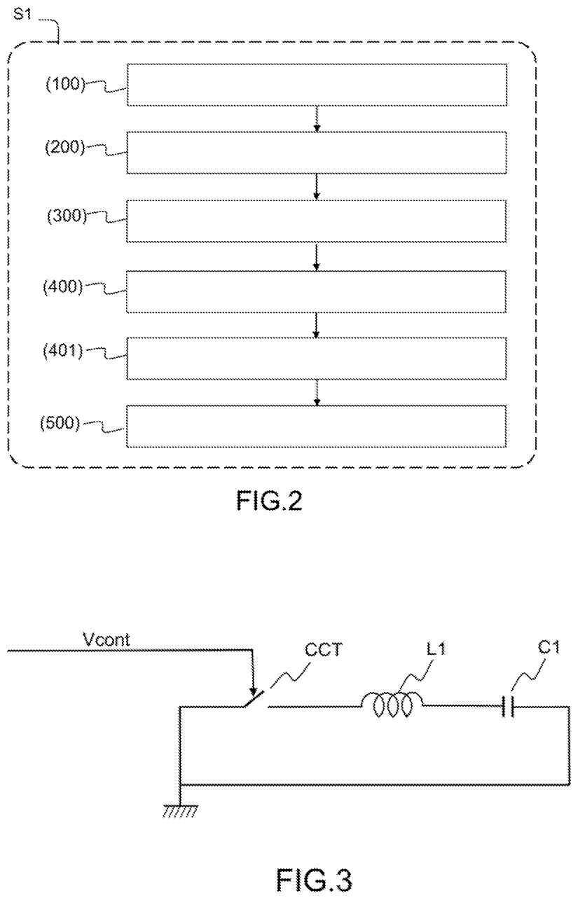

During read out, two tags may transmit their identifiers in the same detection time slot, thus making the message incomprehensible to the reader—a collision is then said to have occurred. The locating unit 2 according to the invention may use collision information to determine the location of the objects stored in the storage unit 6. Collision information may thus be used in the context of the invention. The reader 3 is configured in a mode that does not process collisions. This makes it possible to decrease the time required by the object-locating device according to the invention to carry out the locating operation. FIG. 2 illustrates a flowchart of the steps of one example of an activation sequence of the array of inhibitor circuits according to the invention. This is a non-limiting example, given to illustrate the invention. Those skilled in the art will be able to adapt the sequence depending on the precise time constraints of the application of the invention. The activation sequence will be applied to the example illustrated in FIG. 1a.

The first step (100) of the activation sequence S1 is an initializing step in which the locating unit 2 sends a first order commanding inhibition to the control unit 5 so as to deactivate all the inhibitor circuits 41 to 46. Next, the locating unit 2 sends an inventory read-out order to the RFID reader 3. The processing circuit 31 of the RFID reader 3 generates a first list L₀ containing the identifiers of all the objects present in the storage unit, namely the object 21 and the object 22. With all the inhibition circuits deactivated, the notation employed to designate the list is L₀={21,22}.

The second step (200) consists in activating only the inhibitor circuit 41 associated with storage space 11. Following read out by the antenna 32, the processing circuit 31 of the RFID reader 3 generates a second list L₁ containing only the identifier of the object 22. With the inhibitor circuit 41 activated, the notation employed to designate the list is L₁={22}. This means that the object 21, which does not appear in the list L₁, is stored in the storage space 11 associated with the activated inhibitor circuit 41.

The third step (300) consists in activating only the inhibitor circuit 42 associated with storage space 12. Following read out by the antenna 32, the processing circuit 31 of the RFID reader 3 generates a third list L₂ that is identical to the first list L₀. This makes it possible to deduce that no object is stored in the storage space 12 associated with the activated inhibitor circuit 42.

The fourth step (400) consists in activating only the inhibitor circuit 43 associated with storage space 13. In the same way as step (200), a list L₃ identical to the first list L₀ is obtained. This makes it possible to deduce that no object is stored in the storage space 13 associated with the activated inhibitor circuit 43.

The fifth step (500) consists in activating only the inhibitor circuit 44 associated with storage space 14. Following read out by the antenna 32, the processing circuit 31 of the RFID reader 3 generates a fifth list L₄ containing only the identifier of the object 21. This means that the object 22, which does not appear in the list L₄, is stored in the storage space 14 associated with the activated inhibitor circuit 44.

All the objects detected in the initializing step have been located in the storage unit. It is not necessary to continue to run through the other inhibition configurations. Location is computed (here by elimination) by the locating unit 2 based on the generated lists Lᵢ and on the inhibition configuration of each step of the sequence S1. The locating unit 2 is a programmable computer. The lists Lᵢ are supplied by the RFID reader 3 to the locating unit 2, following a command to supply an exhaustive inventory.

The illustrated example allows the location of each stored object to be accurately determined by activating (or deactivating) the inhibitors 41 to 46 one by one. However, it is envisionable to activate a group of inhibitor circuits so as to cover a predefined region of the storage unit in each step. By way of example, it is envisionable to activate all the inhibitor circuits belonging to the same row (or column) of the storage unit 6 (in the case of a grid of storage spaces). This makes it possible to rapidly locate the objects stored in the storage unit 6. Specifically, if an identifier is present in the inventory list of a row of inactive inhibitor circuits and in the inventory list of a column of inactive inhibitor circuits, it may be deduced that the associated object is present in the grid cell at the intersection of said row and said column.

FIG. 3 illustrates an inhibitor circuit according to a first embodiment of the invention. Each inhibitor circuit comprises an LC circuit comprising at least one inductive element L1 connected in series with at least one capacitive element C1, and a voltage-controlled switch CCT for controlling said LC circuit closed. When the switch CCT is in the off state (high impedance), the series LC circuit is open circuit. When the switch CCT is in the on state, the LC circuit is a closed circuit. The switch CCT is controlled by the signal Vcont, which is delivered by the control unit 5. Control with a voltage provides a better performance, a lower power consumption, a smaller footprint and a better technological robustness than a mechanical switch. The dimensions of the capacitive element C1 and of the inductive element L1 are chosen so as to transpose the resonant frequency f₁ of the RFID tag of the object stored in the associated storage space, to a second resonant frequency f₂ through magnetic coupling when the LC circuit is closed. The voltage at the working frequency (for example 13.56 MHz) across the terminals of the antenna circuit of the tag subjected to the electromagnetic field of the RFID reader may thus pass from a few volts, allowing the RFID chip of the tag to operate, to a residual voltage of a few hundred mV, insufficient to make the RFID chip operate.

By way of example, the inductance of the inductive element is equal to 2.2 pH and the capacitance of the capacitive element C1 is equal to 120 pF. This allows the resonant frequency of the voltage across the antenna circuit of the tag to be shifted from an initial value f₁=13.6 MHz to a second resonant frequency f₂=7.9 MHz when the inhibitor circuit is activated (switch CCT in the on state). The dimensions described in the above example result in a quality factor of 40. Generally, in the context of the invention, the second resonant frequency f₂ is comprised between 5 MHz and 10 MHz.

Generally, when the inhibitor circuit is activated, the voltage gain across the terminals of the associated RFID tag is divided by 10 at the initial working frequency with respect to the non-inhibiting configuration.

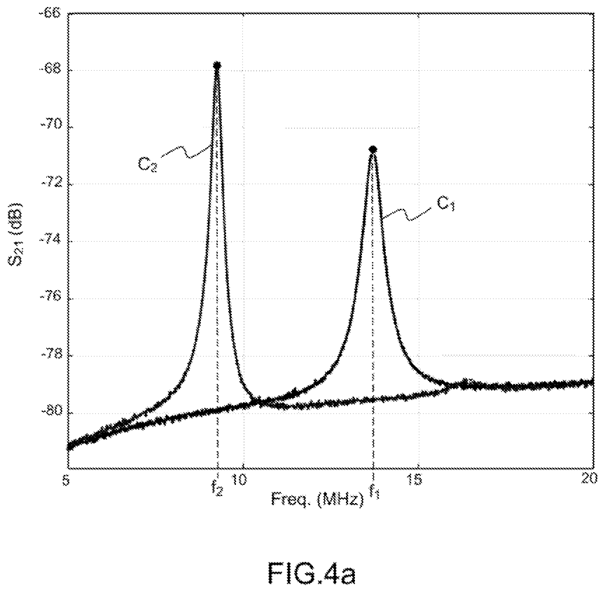

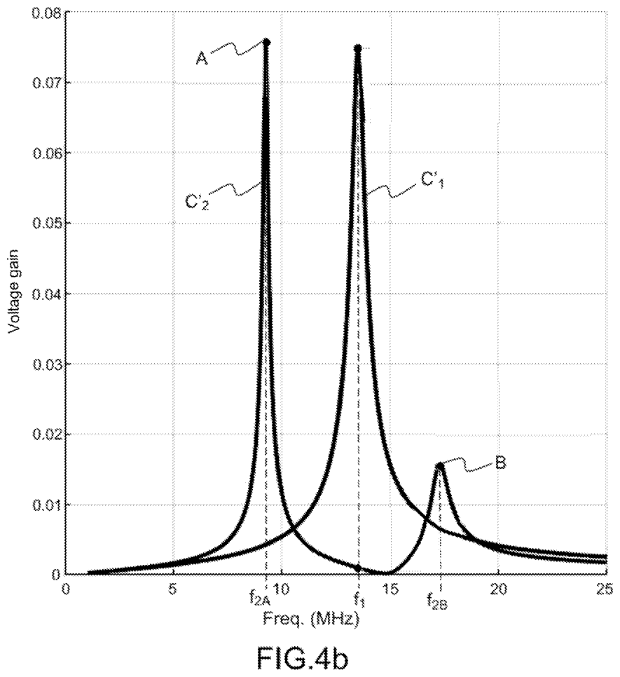

FIG. 4a illustrates one example of the gain curve C1 of the magnetic-field response of the assembly formed by the RFID tag of an object and the inhibitor circuit when the associated inhibitor circuit is deactivated and the gain curve C2 of the magnetic-field response of the assembly formed by the RFID tag of an object and the inhibitor circuit when the associated inhibitor circuit is activated. The RFID tag 210 (or 220) of the object 21 (or 22) is detectable by the RFID reader 3 at a working frequency around the first resonant frequency f₁. The energy exchanged between the antenna 32 and the RFID tag 210 during read out is maximum at this frequency, as illustrated by the peak of the curve C1. Activation of the LC circuit of the inhibitor circuit shifts the gain curve to the curve C2 corresponding to the assembly formed by the inhibitor and RFID tag, which is seen by the antenna 32. Activation of the LC circuit thus transposes the resonant frequency to a value f₂ different from the working frequency f₁ of the RFID antenna 32. Thus, detection of the object 21 (or 22) by the RFID reader 3 is inhibited by the frequency offset between the antenna 32 (designed for detection at f₁) and the target to be read, which has its frequency shifted through magnetic coupling with the activated inhibitor circuit.

FIG. 4b illustrates one example of the gain curve C′1 of the voltage across the terminals of the antenna circuit of the RFID tag of an object when the associated inhibitor circuit is deactivated and the gain curve C′2 of the voltage across the terminals of the antenna circuit of the RFID tag of an object when the associated inhibitor circuit is activated. The RFID tag 210 (or 220) of the object 21 (or 22) is detectable by the RFID reader 3 at a working frequency around the first resonant frequency f₁. The energy exchanged between the antenna 32 and the RFID tag 210 during read out is maximum at this frequency, as illustrated by the peak of the curve C′1. Activation of the LC circuit of the inhibitor circuit shifts the gain curve to the curve C′2 corresponding to the voltage across the terminals of the antenna circuit of the RFID tag inducible by the antenna 32. In the case illustrated, the gain curve C′2 has a first resonant peak A corresponding to the frequency f_{2A} and a second peak B at a frequency f_{2B} higher than the resonant frequency f_{2A}. Activation of the LC circuit thus results in a voltage gain curve with a first resonant frequency f_{2A} lower than the working frequency f₁ and a second resonant frequency f_{2B} higher lower than the working frequency f₁. The voltage gain in the vicinity of the frequency f₁ is divided by 10 with respect to the configuration without inhibition (curve C′1). Thus, detection of the object 21 (or 22) by the RFID reader 3 is inhibited by the frequency offset between the antenna 32 (designed for detection at f₁) and the target to be read, which has its frequency shifted through magnetic coupling with the activated inhibitor circuit.

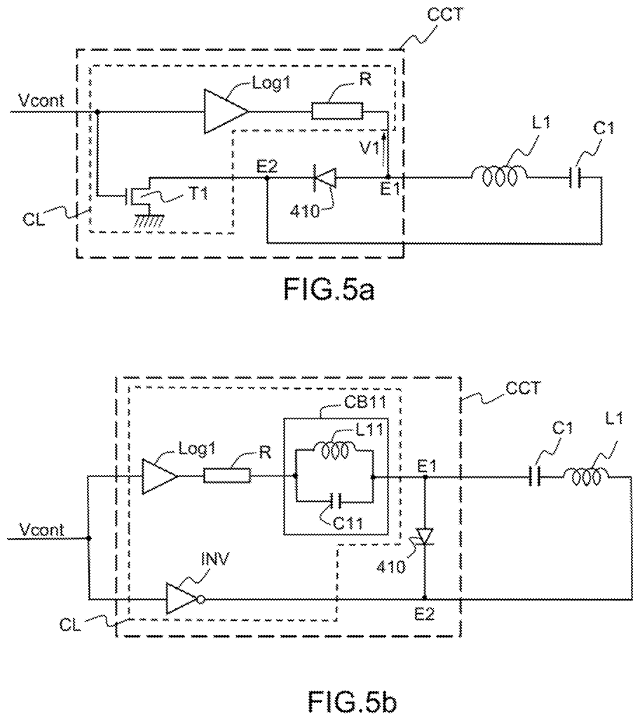

FIG. 5a illustrates an inhibitor circuit according to a second embodiment of the invention, and more particularly one example of implementation of the voltage-controlled switch CCT. The switch CCT comprises a PIN diode 410 (PIN standing for positive-intrinsic-negative) having a first electrode E1 and a second electrode E2. The second electrode E2 is connected to ground through a control transistor T1. The first electrode E1 is connected to the inductive element L1 of the LC circuit. The second electrode E2 is connected to the capacitive element C1 of the LC circuit. The electrical potential on the first electrode E1 and on the second electrode E2 are controlled by a biasing circuit CL. When the PIN diode is forward biased, its impedance is low and it is in an on state. When the PIN diode is reverse biased, its impedance is high and it is in an off state. The biasing circuit CL comprises a logic gate log1 that receives the control signal Vcont delivered by the control unit 5. The logic gate adapts the input signal Vcont (digital signal) to make it compatible with the bias of the PIN diode. The biasing circuit CL further comprises a resistor R connected in series between the output of the logic gate log1 and the node E1, in order to control the current flowing through the PIN diode in its on state. The amplitude of the current flowing through the PIN diode is comprised between 1 mA and 10 mA. When the signal Vcont is in a high logic state, the node E1 is at a high electrical potential received through the logic gate log1 and the resistor R, and the transistor T1 is on so as to decrease the electrical potential of the node E2 to ground. This forward biases the PIN diode 410. This closes the LC circuit and therefore activates the inhibitor circuit.

The advantage of using the PIN diode is that the low-impedance effect in the on state is accentuated for radio-frequency electrical signals. In addition, through adaptation of the currents and voltages at the points where bias is applied to the diode, the reliability and technical robustness of the switch CCT is improved with respect to other switching solutions (e.g. mechanical switching).

FIG. 5b illustrates an inhibitor circuit according to a third embodiment of the invention, and more particularly one alternative example of implementation of the voltage-controlled switch CCT. The biasing circuit CL comprises an inverter INV instead of the transistor T1. The inverter is able to invert the logic state of the control signal Vcont delivered to the electrode E2. The biasing circuit CL further comprises a tank circuit CB₁₁ connected between the first electrode E1 and the resistor R. The tank circuit CB₁₁ comprises a capacitive element C₁₁ connected in parallel with an inductor L₁₁. The tank circuit CB₁₁ is dimensioned to have a high impedance at the working frequency f₁. This makes it possible to isolate the biasing circuit CL from the circuit L₁C₁ of the inhibitor circuit. More particularly, the tank circuit makes it possible to separate the DC electrical signals used to bias the PIN diode, from the high-frequency (HF and more particularly 13.56 MHz) signals of the resonant circuit L₁, C₁.

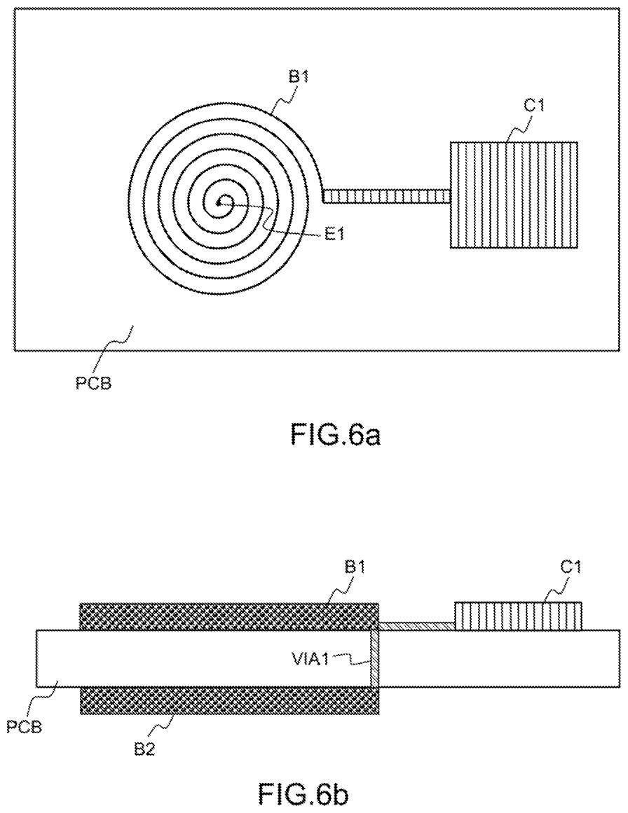

FIG. 6a illustrates a top view of one example of implementation of the inhibitor circuit according to the invention. FIG. 6b illustrates a cross-sectional view of one example of implementation of the inhibitor circuit according to the invention. The illustrated example of implementation is produced on a printed circuit board (PCB). The PCB is referred to as the “selection board” and may be mounted below the storage unit 6.

The inductive element L1 is formed by two flat coils B1 and B2. Each coil comprises a plurality of spiraling metal tracks. The first coil B1 is placed on a first side of the PCB. The second coil B2 is placed on the opposite side of the PCB. The two coils B1 and B2 may be identical. For example, each coil comprises six circular turns for an overall diameter of 14 mm. The turns are metal tracks with a width of 0.2 mm spaced apart at a pitch of 0.4 mm. The two coils B1 and B2 are connected in series through the capacitive element C1. The capacitive element C1 is formed on one side of the PCB substrate.

The first end of the first coil B1 is connected to the first electrode E1 of the PIN diode (not shown here) (or generally to the first electrode of the switch). The second end of the first coil B1 is connected to a terminal of the capacitive element C1.

The first end of the second coil B2 is connected to the second electrode E2 of the PIN diode (not shown here) (or generally to the second electrode of the switch). The second end of the second coil B2 is connected to the other terminal of the capacitive element C1 through a via VIA1.

Alternatively, the capacitive element C1 is placed in a zone inside the circle defined by the coil B1. The PIN diode 410 is placed in a zone outside the circle defined by the coil B1. The electrical connections between the coils B1, B2 and the capacitive element C1 are made by through-vias, through the PCB substrate.

This implementation gives the inhibitor circuit a planar structure allowing simple integration into the object-locating device according to the invention. The plurality of inhibitor circuits may be produced on a single “selection board”, which is mounted below the plane of the storage unit 6. This compact integration ensures better magnetic coupling between the inhibitor circuits and the RFID tags of the objects placed in the associated storage spaces. Specifically, only the thickness of the bottom of the storage unit, which is of the order of a few millimeters, separates the inhibitor circuit from the RFID tag of the stored object.

Alternatively, it is possible to produce each inhibitor circuit on a dedicated printed circuit. This makes it possible to reproduce the same inhibitor-circuit design a number of times depending on the manufacturing requirements.

1. A device for locating objects stored in a storage unit comprising a plurality of storage spaces, each object being equipped with an RFID tag, said object-locating device comprising:
a plurality of inhibitor circuits each intended to be placed in an associated storage space and configured, when one of said objects is stored in the associated storage space and when said inhibitor circuit is activated, to prevent the RFID tag of said object from being read by an RFID reader,
a control unit configured to control activation of the inhibitor circuits in a predetermined activation sequence;
a locating unit configured to control the RFID reader, and to receive, in each step of the activation sequence, a list of identifiers of the objects stored in the storage unit, said list being supplied by the RFID reader, and configured to identify the storage space of each object based on the lists of identifiers and on the activation sequence.

2. The device for locating objects according to claim 1, wherein the inhibitor circuit is able to transpose the resonant frequency of the RFID tag to a second resonant frequency through magnetic coupling when it is activated.

3. The locating device according to claim 2, wherein the second resonant frequency (f₂) is comprised between 5 MHz and 10 MHz.

4. The locating device according to claim 1, wherein the activation sequence comprises:
an initializing step wherein all the inhibitors are deactivated so as to list all the objects stored in the storage unit;
a succession of steps wherein only some of the inhibitors are activated in the activation sequence.

5. The locating device according to claim 1, further comprising said storage unit such that the storage spaces are dimensioned so that the magnetic-coupling coefficient between on the one hand, an inhibitor circuit and, on the other hand, the RFID tag of the object placed in the storage space associated with said inhibitor circuit, is comprised between 0.5 and 1.

6. The locating device according to claim 1, wherein each inhibitor comprises:
an LC circuit comprising at least one inductive element (L1) connected in series with at least one capacitive element (C1); and
a voltage-controlled switch (CCT) for controlling said LC circuit closed.

7. The locating device according to claim 6, wherein the voltage-controlled switch (CCT) comprises a PIN diode having a first electrode (E1) connected to a first control voltage (V1) and a second electrode (E2), the conductivity state of the PIN diode being controlled by a biasing circuit (CL).

8. The locating device according to claim 7, wherein the biasing circuit (CL) comprises:
a logic gate (log1) configured to adapt a digital control signal (VCont) to the bias of the PIN diode;
a resistor (R) connected in series with the logic gate (log1);
a tank circuit (CB₁₁) connected between the first electrode (E1) of the diode and the resistor (R), the tank circuit (CB₁₁) having a high impedance at the resonant frequency of the RFID tag corresponding to the configuration of a deactivated inhibitor circuit.

9. The locating device according to claim 6, wherein the voltage-controlled switch (CCT) is a CMOS transistor.

10. The locating device according to claim 6, wherein the inhibitors are produced on a printed circuit board (PCB), and
in each inhibitor circuit, the inductive element (L1) is formed by at least a first planar coil (B1) comprising a plurality of spiraling metal tracks placed on at least one side of said printed circuit board.

11. The locating device according to claim 10, wherein the inductive element further comprises a circular second planar coil (B2) and wherein the first coil is circular in shape and has a diameter equal to that of the second planar coil.
